(19) United States
(12) Patent Application Publication
(10) Pub. No.: US 2026/0245533 A1
(43) Pub. Date: Aug. 20, 2026

(54) ELECTRONIC MUSICAL INSTRUMENT, CONTROL METHOD AND STORAGE MEDIUM

(71) Applicant: CASIO COMPUTER CO., LTD., Tokyo (JP)

(72) Inventors: Masaru SETOGUCHI, Tokyo (JP); Rie MAEDA, Tokyo (JP)

(73) Assignee: CASIO COMPUTER CO., LTD., Tokyo (JP)

(21) Appl. No.: 19/430,518

(22) Filed: Dec. 23, 2025

(30) Foreign Application Priority Data
Dec. 23, 2024 (JP) 2024-226107

(51) Int. Cl. G10H 1/00; G10H 1/053

(52) U.S. Cl. CPC G10H 1/0008; G10H 1/053; G10H 2210/335; G10H 2210/571; G10H 2220/221

(57) ABSTRACT

An electronic musical instrument includes a processor that determines a first pitch that corresponds to one of chord constituent notes corresponding to chord information at a timing at which an operation element is specified by a user, the chord information being obtained from music piece data, and is closest to a pitch corresponding to the element, in response to a musical tone of the first pitch being not emitted, causes a sound emitter to emit the musical tone, and in response to the musical tone being emitted, causes the sound emitter to emit a musical tone of a second pitch that corresponds to another one of the chord constituent notes and is present in a direction viewed from the first pitch. The direction is identical with a direction in which the pitch corresponding to the element currently specified is viewed from a pitch corresponding to an operation element previously specified.

### CROSS-REFERENCE TO RELATED APPLICATIONS

The present application claims priority under Paris Convention to Japanese Patent Application No. 2024-226107, filed on Dec. 23, 2024, the disclosure of which, including description, claims, abstract and drawings, is incorporated herein by reference in its entirety.

### TECHNICAL FIELD

The present disclosure relates to an electronic musical instrument, a control method and a storage medium.

### DESCRIPTION OF RELATED ART

For electronic musical instruments, there is a known technology of obtaining chord information on a music piece, and emitting a sound by replacing a pitch actually played by its user (player/performer) with one of chord constituent notes on the basis of the chord information on the music piece.

For example, JP 2000-172253 A describes an electronic musical instrument in which chord information is input in the left half region, and a sound is output by replacing a pitch (played pitch) input in the right half region with a chord constituent note of the input chord information. It also describes that as the sound to be output, the chord constituent note closest to the input pitch is selected.

### SUMMARY

According to an aspect of the present disclosure, there is provided an electronic musical instrument including:
a plurality of operation elements;
a sound emitter; and
a processor that
   starts a music piece advancing process based on music piece data, determines a first pitch that (i) corresponds to one of chord constituent notes that correspond to chord information at a timing at which an operation element of the plurality of operation elements is specified by a user, the chord information being obtained from the music piece data, and (i) is closest to a pitch corresponding to the specified operation element,
   in response to a musical tone of the first pitch being not emitted, causes the sound emitter to emit the musical tone of the first pitch, and
   in response to the musical tone of the first pitch being emitted, causes the sound emitter to emit a musical tone of a second pitch that corresponds to another one of the chord constituent notes and is present in a direction viewed from the first pitch, the direction being identical with a direction in which the pitch corresponding to the operation element currently specified is viewed from a pitch corresponding to an operation element of the plurality of operation elements previously specified.

### BRIEF DESCRIPTION OF DRAWINGS

FIG. 1 is a block diagram showing a functional configuration of an electronic musical instrument according to an embodiment of the present disclosure.

FIG. 2 schematically shows main switches included in an operation receiver.

FIG. 3 is an illustration to explain an overview of operation of the electronic musical instrument according to the embodiment.

FIG. 4 is a flowchart of a main process that is executed by a CPU shown in FIG. 1.

FIG. 5 is a flowchart of a function process that is executed in Step S403 in FIG. 4.

FIG. 6 is a flowchart of a music piece advancing process that is executed in Step S404 in FIG. 4.

FIG. 7 shows an example of a root note table.

FIG. 8 shows an example of a chord type table.

FIG. 9 is a flowchart of a performance operation process that is executed in Step S405 in FIG. 4.

FIG. 10 is a flowchart of a keyboard algorithm that is executed in Step S903 in FIG. 9.

FIG. 11 is a flowchart of a first candidate determination process that is executed in Step S1001 in FIG. 10.

FIG. 12 shows an example of a chord constituent note table.

FIG. 13 is an illustration to explain a reason for executing processes in Step S1112 to Step S1114 in FIG. 11.

FIG. 14 is an illustration to explain a reason for executing processes in Step S1115 to Step S1117 in FIG. 11.

FIG. 15 is a flowchart of a second to fifth candidates determination process that is executed in Step S1002 in FIG. 10.

FIG. 16 is a flowchart of a not-being-emitted pitch search process that is executed in Step S1003 in FIG. 10.

FIG. 17 is a flowchart of a mute process that is executed in Step S906 in FIG. 9.

FIG. 18A to FIG. 18D are illustrations to explain advantageous effects of the embodiment exhibited when a player performs legato playing.

FIG. 19A to FIG. 19C are illustrations to explain advantageous effects of the embodiment exhibited when the player plays chords.

### DETAILED DESCRIPTION

The technology described in JP 2000-172253 A may emit a sound that does not reflect the user's performance intention.

One advantage of the present disclosure is that it can emit a good musical tone that reflects the user's performance intention and accords with the user's performance operation.

Hereinafter, one or more embodiments for carrying out the present disclosure will be described with reference to the drawings. Various limitations technically preferable for carrying out the present disclosure are added to the embodiments below.

The technical scope of the present disclosure is not limited to the embodiments below or illustrated examples.

First, the configuration of an electronic musical instrument 1 according to an embodiment of the present disclosure will be described. The electronic musical instrument 1 has a function of, when a key of the electronic musical instrument 1 is pressed by a player as a user, converting the pitch of the pressed key into a pitch calculated on the basis of chord information specified in a music piece and emitting a sound.

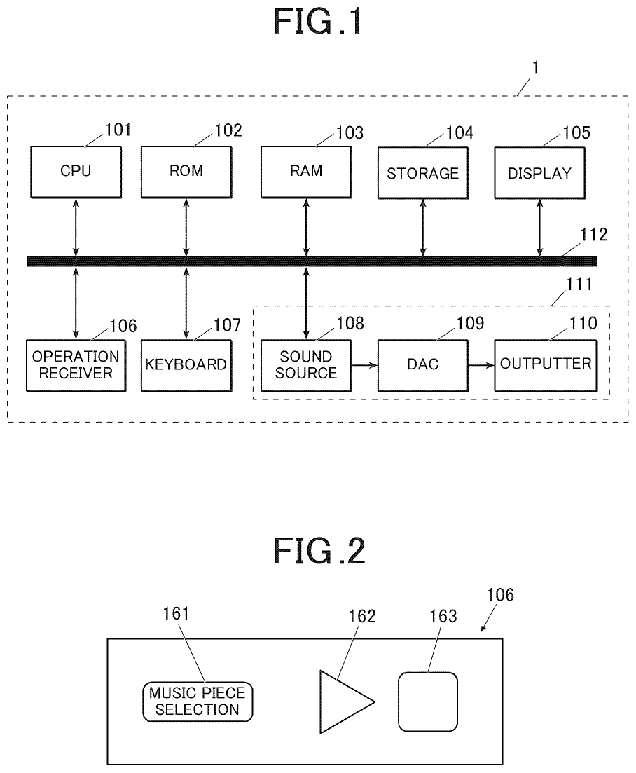

As shown in FIG. 1, the electronic musical instrument 1 includes a central processing unit (CPU) 101, a read only memory (ROM) 102, a random access memory (RAM) 103, a storage 104, a display 105, an operation receiver 106, a keyboard 107, a sound source 108, a digital-to-analog converter (DAC) 109 and an outputter 110. These components are connected with one another via a bus 112.

The CPU 101 (processor) is a computer that controls the components of the electronic musical instrument 1 and functions as a controller. The CPU 101 reads a program specified from programs stored in the ROM 102 or the storage 104, loads the read program into the RAM 103, and executes a process among various processes in cooperation with the loaded program. The CPU 101 may be composed of a plurality of CPUs, and a plurality of processes that is executed by the CPU 101 in this embodiment may be executed by the plurality of CPUs.

The ROM 102 stores programs, various data and so forth. The programs stored in the ROM 102 include a program for executing a keyboard algorithm 201, which will be described later. The RAM 103 provides the CPU 101 with a working memory space and temporarily stores data.

The storage 104 is composed of a nonvolatile semiconductor memory, such as a flash memory, a hard disk drive (HDD) and/or the like. The storage 104 stores programs, various data and so forth. The storage 104 is not limited to being built in the electronic musical instrument 1, but may be or may include an external storage medium(s) attachable to and detachable from the electronic musical instrument 1, such as an external HDD and/or a USB flash drive.

In this embodiment, the storage 104 stores music piece data (e.g., standard MIDI file(s) (SMF)). Each music piece data includes, for each of one or more parts (e.g., melody part, obbligato part, electric guitar part, trumpet part, bass part, drum part, etc.) of a music piece, events, such as note-on events, note-off events and control change events, throughout the music piece from the beginning to the end thereof. The note-on events are each an event that is an instruction on sound emission and includes information on a pitch and a velocity value (intensity) at least. The note-off events are each an event that is an instruction on muting and includes information on a pitch at least. The control change events include events pertaining to control of expression added to musical tones, such as volume and sound quality, and events pertaining to other control, such as master-volume change and panning.

Each music piece data also includes chord information that indicates chord progression from the beginning to the end of the music piece. For example, if the music piece data is SMF, the chord information is stored in the 0^{th} track, which is called “system track”, using a meta event marker. The data format of the meta event of SMF is FFH, an event number, a data length, and data. The event number of the marker is 6, the data length is the number of data bytes, and the data is a string. If this marker is used to indicate a chord name, the string part is the string of the chord name. For example, if the chord name is Cm7, the string length is 3, so that the marker event in this case is FFH, 06H, 03H, ‘C’, ‘m’, ‘7’.

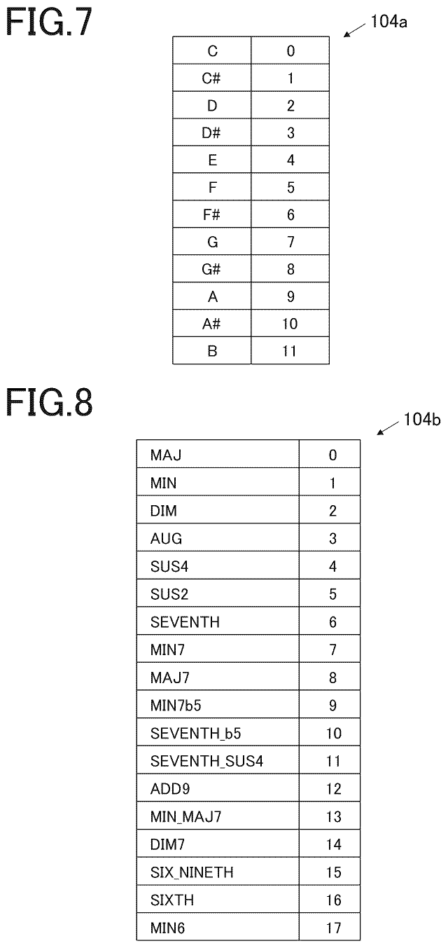

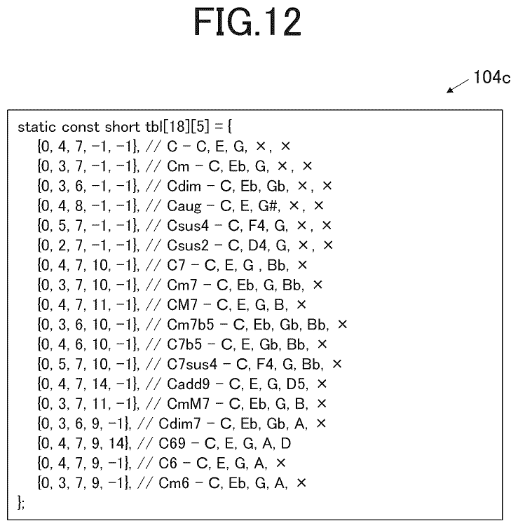

The storage 104 also stores a root note table 104a (shown in FIG. 7), a chord type table 104b (shown in FIG. 8), and a chord constituent note table 104c (shown in FIG. 12). Details of these tables will be described later.

The display 105 is composed of a liquid crystal display (LCD), an electroluminescent (EL) display or the like, and executes various types of display in accordance with display instructions from the CPU 101.

The operation receiver 106 is composed of a plurality of pushbutton switches and so forth. The operation receiver 106 detects operations on the pushbutton switches and outputs operation signals corresponding to the operations to the CPU 101. The operation receiver 106 includes a music piece selection switch 161, a music piece start switch 162 and a music piece stop switch 163 shown in FIG. 2. The music piece selection switch 161 is a switch for selecting a music piece to be played from among a plurality of music piece data. The music piece start switch 162 is a switch for making an instruction to start automatic performance (playback) of a music piece stored in the storage 104. The music piece stop switch 163 is a switch for making an instruction to stop automatic performance of a music piece.

Although in this embodiment, the operation receiver 106 is composed of pushbutton switches, it may be composed of or include a touchscreen or the like attached to the display 105 and output operation signals corresponding to operations on the touchscreen to the CPU 101.

The keyboard 107 includes a plurality of keys (operation elements) and a detector that detects keys pressed/released, and outputs performance information indicating the pitch, velocity and timing of each key pressed/released by the user to the CPU 101. A keypress, namely, a key being pressed, is an operation to specify one of the keys.

The sound source 108 reads waveform data (audio data) stored in advance in the ROM 102 or generates waveform data, and outputs the read or generated waveform data to the DAC 109, in accordance with an instruction from the CPU 101. The DAC 109 executes digital-to-analog conversion on the waveform data output from the sound source 108, thereby outputting analog sounds. The outputter 110 includes an amplifier and a speaker, and amplifies and outputs the analog sounds (musical instrument sounds, etc.) input from the DAC 109. The sound source 108, the DAC 109 and the outputter 110 constitute a sound emitter 111.

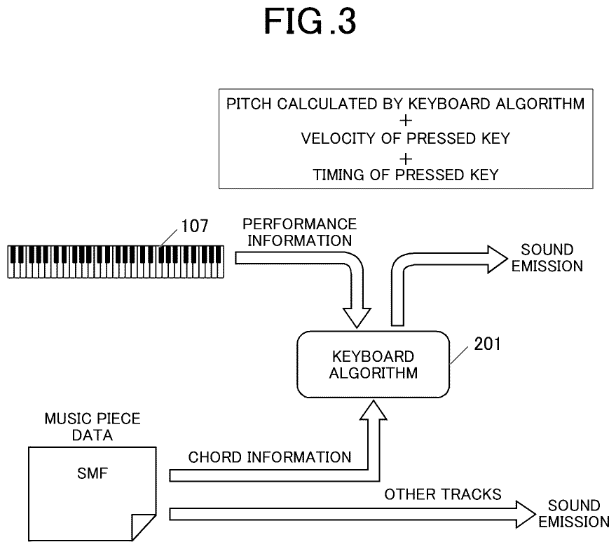

Next, the operation of the electronic musical instrument 1 in this embodiment will be described. The CPU 101 of the electronic musical instrument 1 processes data on a music piece (music piece data) as the music piece progresses. As shown in FIG. 3, the CPU 101 transmits chord information included in the system track in the music piece data to a keyboard algorithm 201, and, as to performance information in the other tracks, instructs the sound source 108 to emit sounds by automatic performance. In accordance with the keyboard algorithm 201, the CPU 101 calculates a pitch to be emitted (produced) in response to an operation (keypress) on the keyboard 107 made (a key pressed) by the player, on the basis of the chord information retrieved from the music piece data and performance information received from the keyboard 107, and instructs the sound source 108 to emit a sound. The sound source 108 having received the sound emission instruction from the CPU 101 emits the musical tone of the pitch at the velocity of the keypress (pressed key).

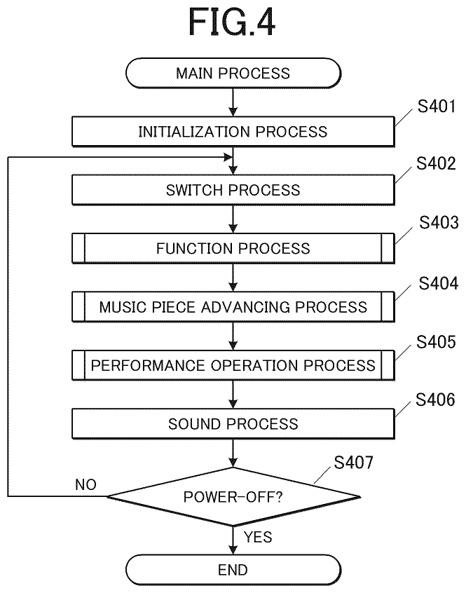

Hereinafter, processes that are executed in the electronic musical instrument 1 will be described with reference to FIG. 4 to FIG. 17. The processes shown in FIG. 4 to FIG. 17 are executed by the CPU 101 in cooperation with the programs stored in the ROM 102 or the storage 104.

When the electronic musical instrument 1 is powered on, the CPU 101 starts a main process shown in FIG. 4. In the main process, the CPU 101 first executes an initialization process (Step S401). In the initialization process, the CPU 101 initializes the components of the electronic musical instrument 1 and also initializes buffers and variables that are used in various processes.

Next, the CPU 101 executes a switch process (Step S402). In the switch process, the CPU 101 obtains operation states of the various switches of the operation receiver 106.

Next, the CPU 101 executes a function process (Step S403). The function process is a process of executing a function in accordance with the operation states of the switches obtained by the switch process.

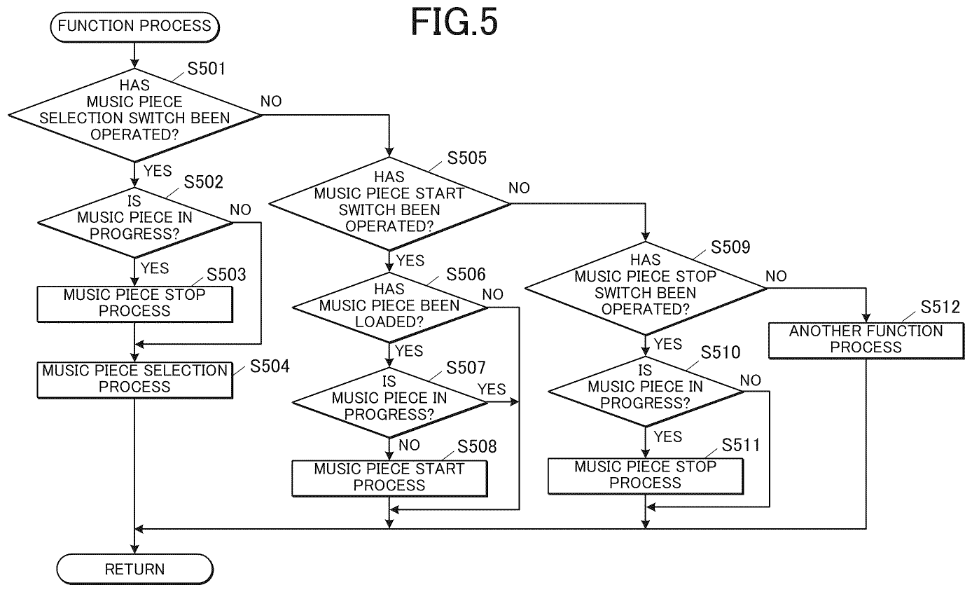

As shown in FIG. 5, in the function process, the CPU 101 first determines whether the music piece selection switch 161 has been operated (Step S501). If the CPU 101 determines that the music piece selection switch 161 has been operated (Step S501; YES), the CPU 101 determines whether a music piece is in progress (in playback) (Step S502). If the CPU 101 determines that no music piece is in progress (Step S502; NO), the CPU 101 proceeds to Step S504. If the CPU 101 determines that a music piece is in progress (Step S502; YES), the CPU 101 stops the music piece (Step S503) and proceeds to Step S504.

In Step S504, the CPU 101 executes a music piece selection process (Step S504) and proceeds to Step S404 in FIG. 4. In the music piece selection process, the CPU 101 causes the display 105 to display a list of names of selectable music pieces and waits for the player to make a music piece selection operation. When the music piece selection operation is made, the CPU 101 reads music piece data of the selected music piece from the storage 104 and loads the data into a music piece storage area of the RAM 103. At the time, if a music piece is already in the music piece storage area of the RAM 103, it is overwritten and deleted.

If the CPU 101 determines in Step S501 that the music piece selection switch 161 has not been operated (Step S501; NO), the CPU 101 determines whether the music piece start switch 162 has been operated (Step S505). If the CPU 101 determines that the music piece start switch 162 has been operated (Step S505; YES), the CPU 101 determines whether music piece data has been loaded into (and is stored in) the music piece storage area of the RAM 103 (Step S506). If the CPU 101 determines that music piece data has not been loaded into the music piece storage area of the RAM 103 (Step S506; NO), the CPU 101 proceeds to Step S404 in FIG. 4.

If the CPU 101 determines that music piece data has been loaded into the music piece storage area of the RAM 103 (Step S506; YES), the CPU 101 determines whether a music piece is in progress (Step S507). If the CPU 101 determines that a music piece is in progress (Step S507; YES), the CPU 101 proceeds to Step S404 in FIG. 4.

If the CPU 101 determines that no music piece is in progress (Step S507; NO), the CPU 101 executes a music piece start process (Step S508) and proceeds to Step S404 in FIG. 4. In the music piece start process, the CPU 101 starts automatic performance (playback) based on the music piece data loaded into the music piece storage area of the RAM 103. For example, the CPU 101 initializes variables and buffers (e.g., out_buf described later) that are used, for example, in a music piece advancing process, which will be described later. For example, the CPU 101 sets each element of out_buf, which will be described later, at −1 as initial settings. The CPU 101 starts the music piece advancing process, which will be described later, on the basis of the music piece data loaded into the music piece storage area of the RAM 103.

If the CPU 101 determines in Step S505 that the music piece start switch 162 has not been operated (Step S505; NO), the CPU 101 determines whether the music piece stop switch 163 has been operated (Step S509). If the CPU 101 determines that the music piece stop switch 163 has been operated (Step S509; YES), the CPU 101 determines whether a music piece is in progress (Step S510). If the CPU 101 determines that a music piece is in progress (Step S510; YES), the CPU 101 executes a music piece stop process (Step S511), which is a process of stopping automatic performance of a music piece that is in progress, and proceeds to Step S404 in FIG. 4. If the CPU 101 determines that no music piece is in progress (Step S510; NO), the CPU 101 proceeds to Step S404 in FIG. 4.

If the CPU 101 determines in Step S509 that the music piece stop switch 163 has not been operated (Step S509; NO), the CPU 101 executes another function process in accordance with an operation made on the operation receiver 106 (Step S512) and proceeds to Step S404 in FIG. 4.

In Step S404 in FIG. 4, the CPU 101 executes the aforementioned music piece advancing process (Step S404). The music piece advancing process is a process that the CPU 101 executes to advance a selected music piece (advance the playback of a selected music piece) in accordance with the progression of time on the basis of the music piece data of the selected music piece.

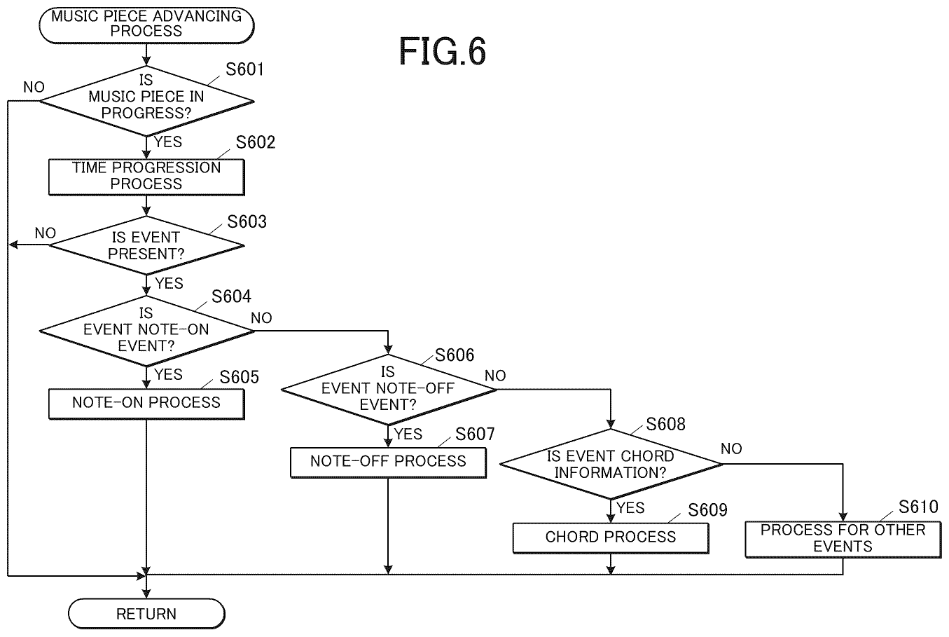

The music piece advancing process, which is executed in Step S404 in FIG. 4, will be described with reference to FIG. 6. The music piece advancing process is a process of advancing a music piece in accordance with the progression of time.

In the music piece advancing process, the CPU 101 first determines whether a music piece is in progress by automatic performance (Step S601). If the CPU 101 determines that no music piece is in progress by automatic performance (Step S601; NO), the CPU 101 exits the music piece advancing process and proceeds to Step S405 in FIG. 4. If the CPU 101 determines that a music piece is in progress by automatic performance (Step S601; YES), the CPU 101 executes a time progression process (Step S602). The time progression process is a process of advancing a processing position in the music piece data in accordance with the elapsed time from the last time the time progression process was executed to the present.

Next, the CPU 101 determines whether any event to be processed is present at the processing position in the music piece data (Step S603). If the CPU 101 determines that no event to be processed is present at the processing position in the music piece data (Step S603; NO), the CPU 101 exits the music piece advancing process and proceeds to Step S405 in FIG. 4.

If the CPU 101 determines that an event to be processed is present at the processing position in the music piece data (Step S603; YES), the CPU 101 determines whether the event is a note-on event (Step S604). If the CPU 101 determines that the event is a note-on event (Step S604; YES), the CPU 101 executes a note-on process (Step S605) and proceeds to Step S405 in FIG. 4. In the note-on process, the CPU 101 generates sound emission instruction information to cause the sound emitter 111 to emit a musical tone corresponding to a note number and a velocity included in the note-on event, and outputs the generated sound emission instruction information to the sound source 108.

If the CPU 101 determines in Step S604 that the event is not a note-on event (Step S604; NO), the CPU 101 determines whether the event is a note-off event (Step S606). If the CPU 101 determines that the event is a note-off event (Step S606; YES), the CPU 101 executes a note-off process (Step S607) and proceeds to Step S405 in FIG. 4. In the note-off process, the CPU 101 generates mute instruction information to cause the sound emitter 111 to stop (mute) a musical tone corresponding to a note number included in the note-off event, and outputs the generated mute instruction information to the sound source 108.

If the CPU 101 determines in Step S606 that the event is not a note-off event (Step S606; NO), the CPU 101 determines whether the event is chord information (Step S608). If the CPU 101 determines that the event is chord information (Step S608; YES), the CPU 101 executes a chord process (Step S609) and proceeds to Step S405 in FIG. 4.

In the chord process, the CPU 101 first extracts the root and chord type of the chord from the chord name specified by the string of the marker event in the music piece data. Next, the CPU 101 refers to the root note table 104a shown in FIG. 7 and the chord type table 104b shown in FIG. 8, and stores an identification number (pitch name number) representing the pitch name of the chord in a variable root, and stores an identification number (chord type number) representing the chord type of the chord in a variable type. As shown in FIG. 7, the root note table 104a is a table in which pitch names (C, C#, D, . . . ) of roots of chords and pitch name numbers (0, 1, 2, . . . ) are associated with one another and stored. The pitch names of roots of chords are given the pitch name numbers, starting from 0 for C to 11 for B. As to pitch names that are enharmonic, such as C#and D♭, only the pitch name with # and the pitch name number are stored. In the drawings and the description hereinafter, “♭” is represented by “b”. As shown in FIG. 8, the chord type table 104b is a table in which chord types and chord type numbers (0, 1, 2, . . . ) are associated with one another and stored. In this embodiment, there are 18 chord types. Since it is possible to play a music piece with fewer chord types than the above, the number of chord types may be less than the above, or conversely, the number of chord types may be more than the above to correspond to tension chords with 9^{th}, 11^{th} and/or the like. For example, according to FIG. 7 and FIG. 8, if the string of the marker event is Cm7, 0 is stored in the variable root, and 7 is stored in the variable type. As another example, if the string of the marker event is B7b5, 11 is set (stored) in the variable root, and 10 is set (stored) in the variable type.

If the CPU 101 determines in Step S608 that the event is not chord information (Step S608; NO), the CPU 101 executes a process for other events (Step S610) and proceeds to Step S405 in FIG. 4.

Events that are processed in Step S610 are all events except note-on events, note-off events, and chord information. Examples thereof include tempo change included in the system track, a process of End of Track (EOT) present at the end of track data (to end a process on the track), program change as an instruction on tone change, and control change of expression or the like as an instruction on volume change. When all tracks reach the EOT event and the playback process of all the tracks finish, the music piece stops and the state becomes a music piece stop state.

In Step S405 in FIG. 4, the CPU 101 executes a performance operation process (Step S405). In the performance operation process, the CPU 101 executes, on the basis of performance information input from the keyboard 107, a process corresponding to an operation (performance operation) on the keyboard 107 made by the player. For example, if the input performance information is a note-on event, the CPU 101 transmits a pitch specified by the note-on event to the keyboard algorithm 201, determines a pitch to be emitted in accordance with the keyboard algorithm 201, generates sound emission instruction information that instructs the sound emitter 111 to emit the musical tone of the determined pitch at a velocity value specified by the performance operation, and outputs the generated sound emission instruction information to the sound source 108 of the sound emitter 111. Details thereof will be described later.

Next, the CPU 101 executes a sound process (Step S406). In the sound process, the CPU 101 causes the sound emitter 111 to emit, mute or change a musical tone on the basis of the sound emission instruction information, mute instruction information or instruction information on tone change, volume change or the like output to the sound source 108 in the music piece advancing process or the performance operation process.

Next, the CPU 101 determines whether a power switch included in the operation receiver 106 has been pressed (i.e., whether an instruction to power off has been made) (Step S407). If the CPU 101 determines that the power switch included in the operation receiver 106 has not been pressed (Step S407; NO), the CPU 101 returns to Step S402 to repeat the processes in Steps S402 to S407. If the CPU 101 determines that the power switch included in the operation receiver 106 has been pressed (Step S407; YES), the CPU 101 ends the main process.

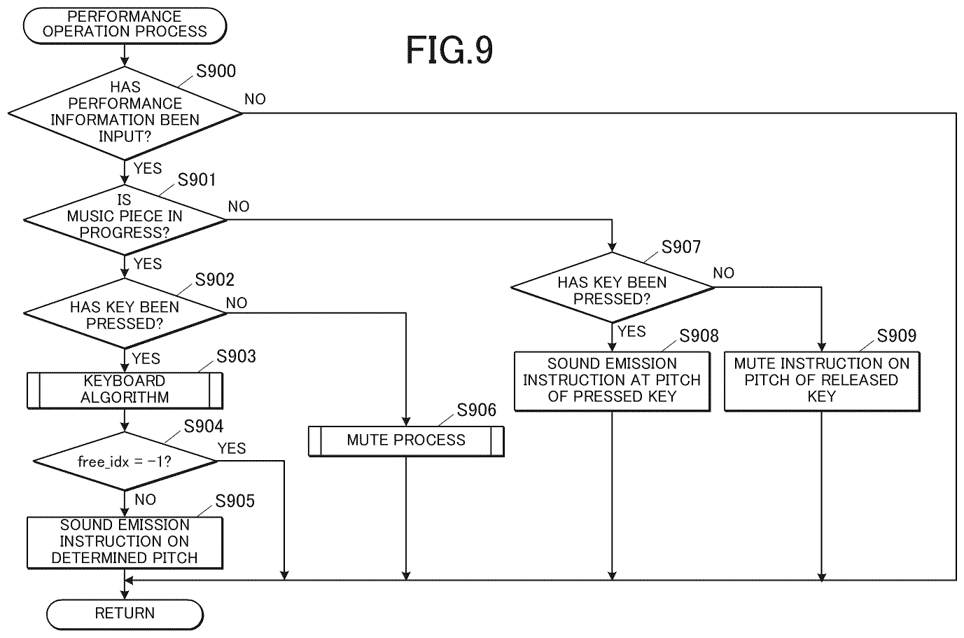

Hereinafter, the performance operation process will be described in detail with reference to FIG. 9 to FIG. 17. As shown in FIG. 9, in the performance operation process, the CPU 101 first determines whether performance information has been input from the keyboard 107 (Step S900). If the CPU 101 determines that no performance information has been input (Step S900; NO), the CPU 101 ends the performance operation process.

If the CPU 101 determines that performance information has been input from the keyboard 107 (Step S900; YES), the CPU 101 determines whether a music piece is in progress (Step S901). If the CPU 101 determines that a music piece is in progress (Step S901; YES), the CPU 101 determines whether the input performance information is information indicating that a key has been pressed (Step S902). If the CPU 101 determines that the input performance information indicates that a key has been pressed (Step S902; YES), the CPU 101 executes a keyboard algorithm to determine a pitch to be emitted (Step S903). Although this keyboard algorithm is the keyboard algorithm 201 shown in FIG. 3, it is simply referred to as “keyboard algorithm” because it will be described as a subroutine of software.

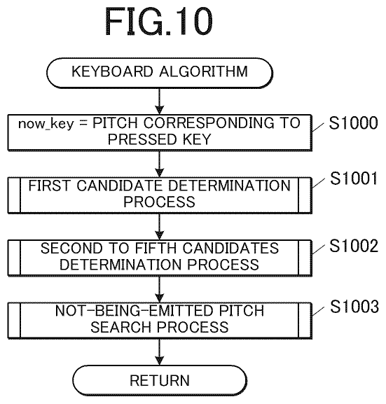

Hereinafter, the keyboard algorithm that is executed in Step S903 will be described with reference to FIG. 10 to FIG. 16. The keyboard algorithm is a process of determining a pitch to be emitted in response to a pressed key on the basis of chord information on a music piece. In the keyboard algorithm, the CPU 101 first calculates, as candidates for the pitch to be emitted, five candidates that are the first to fifth candidates, and then checks whether the candidates are being emitted in order, starting from the first candidate, and selects/determines one candidate that is not being emitted as a determined pitch. If all the candidates from the first to fifth candidates are being emitted, the CPU 101 determines that sound emission is impossible and sets −1 in a variable free_idx and exits the performance operation process.

Hereinafter, the reason why the number of candidates is five will be described. Assume that the player presses four keys for four notes with four fingers of his/her left hand or right hand, and then presses another key with the fifth finger. In this case, when the player presses a key with the fifth finger, among the candidates for sound emission, the first to fourth candidates may be already being emitted. In order that sound emission can be executed even in such a case, the number of candidates is set at five. In other words, even when the player presses keys with five fingers of one hand at the same time, sounds can be emitted as to all the keys. In a case where the player presses keys with both hands at the same time, shortage of candidates for sound emission due to already being emitted does not usually occur because of the pitch difference between keys that are pressed by the right hand and the left hand. In this application, the maximum number of chord constituent notes is set at five, but there is no limitation on the number of pressed keys with which sounds can be emitted at the same time. The number of pressed keys with which sounds can be emitted at the same time can be set at a number suitable for the performance of the electronic musical instrument.

As shown in FIG. 10, in the keyboard algorithm, the CPU 101 first stores the pitch corresponding to the pressed key in a variable now_key (Step S1000). In this embodiment, the pitch that is stored in the variable now_key is a note number defined in the Musical Instrument Digital Interface (MIDI) standard. That is, C4, which is the middle key of a normal 88-key piano, is represented by 60, C8, which is the rightmost key (highest note) thereof, is represented by 108, and A0, which is the leftmost key (lowest note) thereof, is represented by 21.

Next, the CPU 101 executes a first candidate determination process (Step S1001). In the first candidate determination process, the CPU 101 determines, among the chord constituent notes corresponding to the chord information (chord information obtained in the chord process) at the current timing (key-pressed timing) in the music piece that is in progress, the pitch (first pitch) closest to the pitch corresponding to the key pressed by the player, as the first candidate.

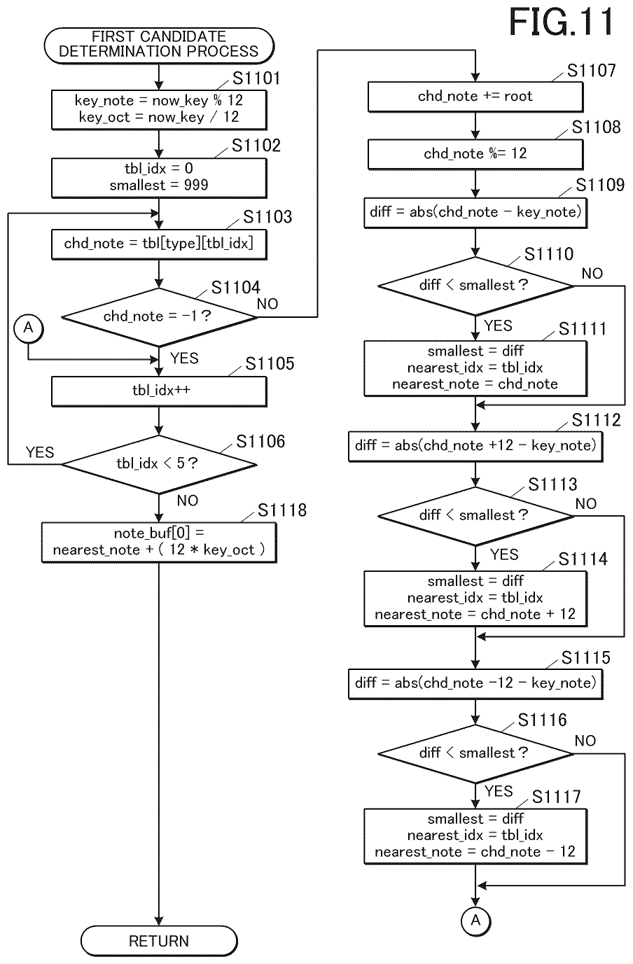

The flow of the first candidate determination process will be described in detail with reference to FIG. 11. The CPU 101 first stores, in a variable key_note, the residue obtained by dividing the pitch in the variable now_key by the number of notes of one octave, which is 12. Similarly, the CPU 101 stores, in a variable key_oct, the quotient obtained by dividing the value of the variable now_key by 12 (Step S1101).

The residue obtained by dividing the pitch by 12 corresponds to the pitch name that represents the pitch within one octave. In this embodiment, as shown in FIG. 7, pitch name numbers are assigned to pitch names in order, starting from 0 for the pitch name C up to 11. That is, C4 and C8 have the same pitch name C, and are both represented by the pitch name number 0. Therefore, the value of the variable key_note is the pitch name number representing the pitch name of the pitch corresponding to the key currently pressed. Meanwhile, the quotient obtained by dividing the pitch by 12 represents the octave region including the pitch. For example, since the quotient obtained by dividing 21, which is the note number of A 0 as the lowest pitch of an 88-key piano, by 12 is 1, the octave region is 1. As another example, since the quotient obtained by dividing 60, which is the note number of C4, by 12 is 5, the octave region is 5. As shown in Formula 1 below, a pitch can be calculated from a pitch name number and an octave region.

$$Pitch = 12 \times Octave Region + Pitch Name Number \qquad ( Formula 1 )$$

For example, if the pitch name is C and the octave region is 5, 12×5+0=60, so that the pitch C4 can be calculated.

Next, the CPU 101 initializes a variable tbl_idx to set 0, and also initializes a variable smallest to set 999, which is a sufficiently large number (Step S1102). The variable tbl_idx is a variable used as an index of the chord constituent note table 104c shown in FIG. 12. The variable smallest is a variable in which the minimum difference value between the pitch name number of the pressed key and the pitch name number of a chord constituent note.

The chord constituent note table 104c shown in FIG. 12 is a two-dimensional array of 18 rows×5 columns in which chord constituent notes of each chord type in the case where the root is C are enumerated starting from the lower pitch side. The chord constituent notes of each chord type are described by pitch name numbers. The “−1” indicates that no chord constituent note is present. In order to calculate, from the chord constituent note table 104c, chord constituent notes of a chord with the root different from that of the chord constituent note table 104c, the pitch name number of the root is added to the pitch name number of each chord constituent note. For example, in the case of C major, the root is 0, so that the chord constituent notes are 0, 4 and 7 (C, E and G), whereas in the case of G major, the pitch name number corresponding to the root G is 7 according to FIG. 7, so that 7 is added to each chord constituent note, and accordingly the chord constituent notes are 7, 11 and 14 (G, B and D). In FIG. 12, for clarity, the chord type and pitch names of chord constituent notes are given to each row of the two-dimensional array as comments. Each element of the chord constituent note table 104c shown in FIG. 12 can be identified by tbl[a][b], where “a” is an index indicating the position of a chord type (chord type number), and “b” is an index indicating the position of a chord constituent note when chord constituent notes are enumerated starting from the lower pitch side.

Next, the CPU 101 selects one chord constituent note corresponding to the chord information at the current timing in the music piece that is in progress, from the chord constituent note table 104c on the basis of the chord type number set in the variable type in S609 in FIG. 6 and the variable tbl_idx, and stores the selected chord constituent note in a variable chd_note (Step S1103).

Next, the CPU 101 determines whether the value of the variable chd_note is −1 (Step S1104). If the CPU 101 determines that the value of the variable chd_note is −1 (Step S1104; YES), since the chord constituent note is an invalid chord constituent note, the CPU 101 proceeds to Step S1105 to proceed to the next chord constituent note. In Step S1105, the CPU 101 increases the variable tbl_idx by one (Step S1105), and if the CPU 101 determines that the variable tbl_idx is less than 5 (Step S1106; YES), the CPU 101 returns to Step S1103 to again obtain a chord constituent note from the chord constituent note table 104c. However, in this embodiment, once −1 is obtained as the value of the variable chd_note, there is no more valid chord constituent note. Therefore, practically, Step S1118 is executed with the chord constituent note processed by this point.

If the CPU 101 determines that the value of the variable chd_note is not −1 (Step S1104; NO), the CPU 101 adds the pitch name number of the root set in the variable root in S609 to the variable chd_note (Step S1107). This process calculates one of the chord constituent notes corresponding to the current chord name in the music piece.

Next, the CPU 101 sets, in the variable chd_note, the residue obtained by dividing the variable chd_note by 12 (Step S1108). The process in Step S1108 is a process for bringing the pitch name number of the calculated chord constituent note within the range of one octave. For example, among the abovementioned chord constituent notes of G major, 7 remains unchanged with the residue of 12 taken, but 14 becomes 2. In other words, the process in Step S1108 makes the value of the variable chd_note be one of 0 to 11. This process is necessary to calculate the pitch name closest to the note corresponding to the pressed key.

Next, the CPU 101 sets, in a variable diff, the absolute value of the difference between the value of the variable chd_note and the value of the variable key_note set in Step S1101 (Step S1109). In other words, the difference between the pitch name number of the selected chord constituent note and the pitch name number corresponding to the pressed key is set in the variable diff.

Next, the CPU 101 determines whether the value of the variable diff is less than the variable smallest (minimum difference) (Step S1110). Step S1110 at the first time is always “YES” because 999 is set in the variable smallest at the first time. If the CPU 101 determines that the value of the variable diff is less than the variable smallest (Step S1110; YES), the CPU 101 sets the value of the variable diff in the variable smallest, the value of the variable tbl_idx in a variable nearest_idx, and the value of the variable chd_note in a variable nearest_note (Step S1111), and proceeds to Step S1112. As a result, the difference between the pitch name number of the chord constituent note currently closest to the pressed key and the pitch name number of the pressed key, the index of the chord constituent note at this point, and the pitch name number of the chord constituent note are set in their corresponding variables. If the CPU 101 determines that the value of the variable diff is not less than the variable smallest (Step S1110; NO), the CPU 101 proceeds to Step S1112.

In Step S1112, the CPU 101 sets, in the variable diff, the absolute value of the difference between the value obtained by adding 12 to the variable chd_note, namely, the pitch name number obtained by raising the pitch name number in the variable chd_note by one octave, and the variable key_note (Step S1112). Then, the CPU 101 determines whether the value of the variable diff, which indicates the difference between the one-octave-higher pitch name number and the pitch name number of the pressed key, is less than the value of the variable smallest (Step S1113).

If the CPU 101 determines that the value of the variable diff, which indicates the difference between the one-octave-higher pitch name number and the pitch name number of the pressed key, is less than the value of the variable smallest (Step S1113; YES), the CPU 101 determines that a chord constituent note further closer to the pressed key has been found, and sets the value of the variable diff in the variable smallest, the value of the variable tbl_idx in the variable nearest_idx, and the value obtained by adding 12 to the variable chd_note, namely, the one-octave-higher pitch name number, in the variable nearest_note (Step S1114), and proceeds to Step S1115. If the CPU 101 determines that the value of the variable diff, which indicates the difference between the one-octave-higher pitch name number and the pitch name number of the pressed key, is not less than the value of the variable smallest (Step S1113; NO), the CPU 101 proceeds to Step S1115.

In Step S1115, the CPU 101 sets, in the variable diff, the absolute value of the difference between the value obtained by subtracting 12 from the variable chd_note, namely, the pitch name number obtained by lowering the pitch name number of the variable chd_note by one octave, and the variable key_note (Step S1115). Then, the CPU 101 determines whether the value of the variable diff, which indicates the difference between the one-octave-lower pitch name number and the pitch name number of the pressed key, is less than the value of the variable smallest (Step S1116).

If the CPU 101 determines that the value of the variable diff, which indicates the difference between the one-octave-lower pitch name number and the pitch name number of the pressed key, is less than the value of the variable smallest (Step S1116; YES), the CPU 101 determines that a chord constituent note further closer to the pressed key has been found, and sets the value of the variable diff in the variable smallest, the value of the variable tbl_idx in the variable nearest_idx, and the value obtained by subtracting 12 from the variable chd_note, namely, the one-octave-lower pitch name number, in the variable nearest_note (Step S1117), and proceeds to Step S1105. If the CPU 101 determines that the variable diff, which indicates the difference between the one-octave-lower pitch name number and the pitch name number of the pressed key, is not less than the value of the variable smallest (Step S1116; NO), the CPU 101 proceeds to Step S1105.

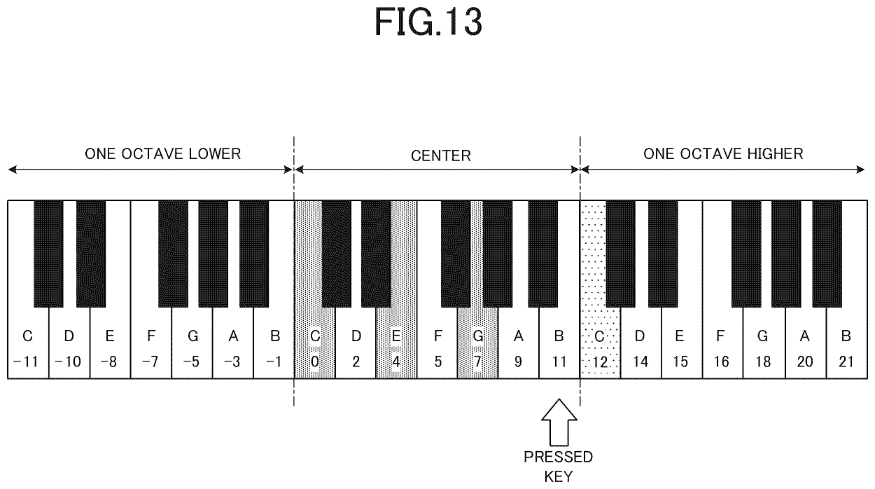

Hereinafter, with reference to FIG. 13, the reason why the absolute value of the difference between the value obtained by adding 12 to the variable chd_note, namely, the pitch name number obtained by raising the pitch name number of the variable chd_note by one octave, and the variable key_note, which indicates the pitch name number corresponding to the pressed key, is compared with the variable smallest will be described. In this embodiment, pitches are converted into pitch names to limit them to (within) the range of one octave, and they are treated as pitch name numbers of 0 to 11. This greatly reduces the number of data that make up the chord constituent note table 104c, and also simplifies the process of obtaining pitches close to pressed keys. The processes in Step S1109 to Step S1111 correspond to comparison of the difference between a chord constituent note in the key region with “Center” written in FIG. 13 and the pitch name of a pressed key with the minimum difference by that point. As an example, take a look at a case where the chord is C major and the pitch name corresponding to the pressed key is B (11). The pitch names of the chord constituent notes of C major are C (0), E (4) and G (7), which are shaded in FIG. 13. The chord constituent note having the smallest difference from the pressed key B (11) is G (7). Therefore, if the minimum difference is obtained only in the center part, the chord constituent note G is selected. In reality, however, the chord constituent note closest to the pressed key B is C of one octave higher that is on the right of the pressed key B dotted in FIG. 13. In order to select this C of one octave higher as the pitch name closest to the pressed key, it is necessary to perform the processes in Step S1112 to Step S1114.

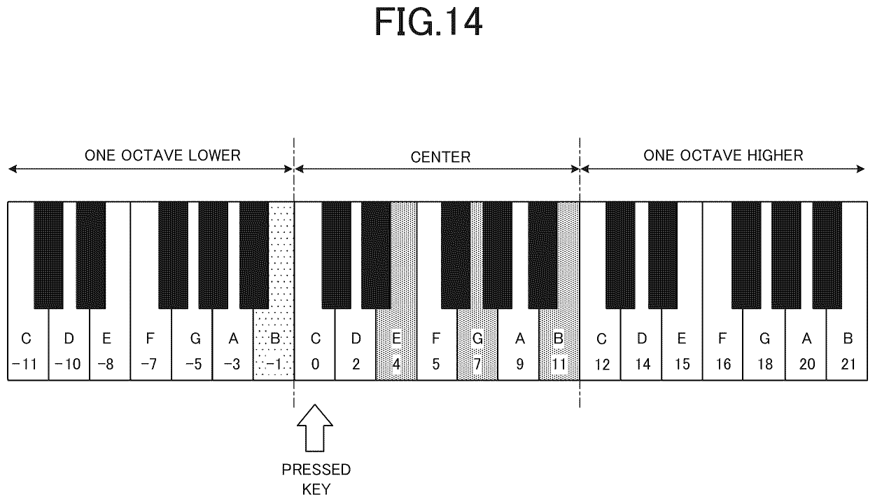

The same may apply to the one octave lower side. As an example, take a look at a case where the chord is E minor and the pitch name corresponding to the pressed key is C (0). The pitch names of the chord constituent notes of E minor are E (4), G (7) and B (11), which are shaded in FIG. 14. Therefore, if the comparison with the pressed key is made only in the center part, the chord constituent note E is selected as the chord constituent note closest to the pressed key C. In reality, however, the chord constituent note closest to the pressed key C is B of one octave lower that is on the left of the pressed key C dotted in FIG. 14. In order to select this B of one octave lower as the pitch name closest to the pressed key, it is necessary to perform the processes in Step S1115 to Step S1117.

Returning to FIG. 11, in Step S1105, the CPU 101 increases the variable tbl_idx, which indicates the index of chord constituent notes, by one (Step S1105), and determines whether the value of the variable tbl_idx is less than 5 (Step S1106). If the CPU 101 determines that the value of the variable tbl_idx is less than 5 (Step S1106; YES), the CPU 101 returns to Step S1103 and repeats the processes in Step S1103 and thereafter.

If the CPU 101 determines that the value of the variable tbl_idx is 5 or more (Step S1106; NO), the CPU 101 calculates a pitch from the value of the variable nearest_note and the value of the variable key_oct, which indicates the octave region of the pressed key, on the basis of Formula 1, and sets the calculated pitch in the 0^{th} element that is the first element of note_buf (Step S1118), which is the buffer of candidates for sound emission (sound emission candidate buffer), and proceeds to Step S1002 in FIG. 10.

The first candidate set in note_buf[0] by the first candidate determination process is the pitch of the chord constituent note closest to the pitch of the pressed key of the current chord in the music piece. In this embodiment, the comparison of the difference between the pitch name number of a chord constituent note and the pitch name number of the pressed key with the minimum difference by that point is executed in order starting from the lowest chord constituent note, and therefore a candidate pitch on the lower pitch side is selected if there are candidate pitches having the same difference. More specifically, if the pressed key is D (2), C (0) and E (4) both have a difference of 2 from D, but C is selected because C is compared with D (i.e., pressed key) earlier between the two. However, this is one embodiment, and therefore a candidate pitch on the higher pitch side may be selected if there are candidate pitches having the same difference.

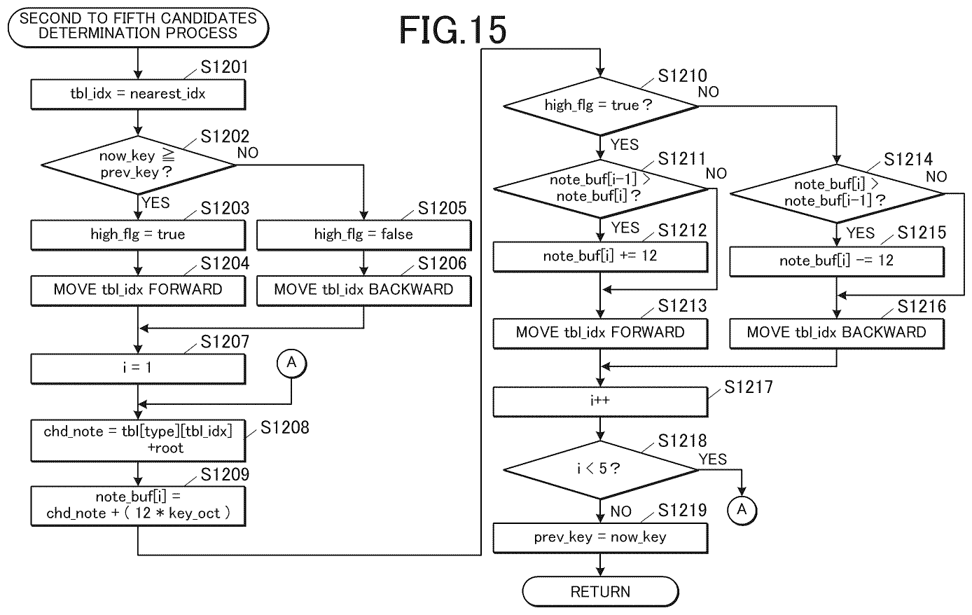

In Step S1002 in FIG. 10, the CPU 101 executes a second to fifth candidates determination process. The second to fifth candidates are candidates for the second pitch to be emitted if the first candidate is being emitted. As shown in FIG. 15, in the second to fifth candidates determination process, the CPU 101 first sets, in the variable tbl_idx, the value of the variable nearest_idx, which indicates an index of the chord constituent note closest to the pitch of the pressed key, calculated by the first candidate determination process (S1201). For example, if the chord constituent note closest to the pitch of the pressed key in C major chord is C, 0 is set in the index (variable tbl_idx), whereas if it is E, 1 is set in the index (variable tbl_idx).

Next, the CPU 101 determines whether the value of the variable now_key, which indicates the pitch of the key (pressed-key's pitch) currently pressed, is equal to or more than the value of a variable prev_key, which indicates the one-previous pressed-key's pitch (Step S1202). By the process in Step S1202, the CPU 101 determines whether in the player's performance, the pressed key (pitch of the pressed key) is in an ascending direction or in a descending direction. In this embodiment, if the CPU 101 determines that the value of the variable now_key is equal to the value of the variable prev_key, which indicates the one-previous pressed-key's pitch, the CPU 101 proceeds to Step S1203, but may proceed to Step S1205 instead.

If the CPU 101 determines that the value of the variable now_key is equal to or more than the value of the variable prev_key (Step S1202; YES), the CPU 101 sets true in high_flg, which is a flag indicating that the pressed key is in the ascending direction (Step S1203).

Next, the CPU 101 moves the value of the variable tbl_idx forward (Step S1204) and proceeds to Step S1207. The expression “moves the value of the variable tbl_idx forward” means to proceed to the next element by adding one to the index (variable tbl_idx), but if the element is −1, which indicates an invalid element, the CPU 101 moves the value of the variable tbl_idx further forward. When the end of the array is reached, the CPU 101 resets the value of the variable tbl_idx to 0 to return the value of the variable tbl_idx to the top of the array. For example, in a case where the chord is C major and the value of the variable tbl_idx is 2, when this is increased by one, it becomes 3. Since the third element of C major is −1 according to FIG. 12, the CPU 101 further increases the value of the variable tbl_idx to 4, but since the fourth element is also −1, the CPU 101 returns the value of the variable tbl_idx to 0 to indicate 0 of the 0^{th} element.

If the CPU 101 determines in Step S1202 that the variable now_key is less than the variable prev_key (Step S1202; NO), the CPU 101 sets false in high_flg (Step S1205).

Next, the CPU 101 moves the value of the variable tbl_idx backward (Step S1206) and proceeds to Step S1207. The expression “moves the value of the variable tbl_idx backward” means to return to the previous element by subtracting one from the index (variable tbl_idx). When the top (i.e., 0) of the array is reached, the CPU 101 sets 4, which indicates the end of the array, in the variable tbl_idx. As with the case of moving the value of the variable tbl_idx forward, if the element is −1 , which indicates an invalid element, the CPU 101 moves the value of the variable tbl_idx further backward. For example, in a case where the chord is C major and the value of the variable tbl_idx is 0, when this is moved backward, it becomes 4, which indicates the end of the array. As shown in FIG. 12, since the fourth element of C major is −1 , the CPU 101 decreases the value of the variable tbl_idx to 3, but since the third element is also-1, the CPU 101 further decreases the value of the variable tbl_idx to indicate 7 of the second element.

In Step S1207, the CPU 101 sets 1 in a variable i, which is used as a loop counter (Step S1207).

Next, the CPU 101 obtains, from the chord constituent note table 104c, the pitch name number of the chord constituent note corresponding to the value of the variable type, which indicates the chord type of the current chord, and the value of the variable tbl_idx, adds the value of the variable root to the obtained pitch name number, and sets the result in the variable chd_note (Step S1208). Next, the CPU 101 calculates a pitch from the value of the variable chd_note and the value of the variable key_oct, which indicates the octave region of the pressed key, on the basis of Formula 1, and sets the result in the i^{th} element of note_buf (Step S1209).

Next, the CPU 101 determines whether high_flg is true (Step S1210). If the CPU 101 determines that high_flg is true (Step S1210; YES), the CPU 101 determines whether the one-previous element of note_buf is more than the current element of note_buf (Step S1211). If the CPU 101 determines that the one-previous element is more than the current element (Step S1211; YES), the CPU 101 adds 12 to the current element (Step S1212) and proceeds to Step S1213. In other words, the CPU 101 ascends the pitch by one octave. If the CPU 101 determines that the one-previous element is not more than the current element (Step S1211; NO), the CPU 101 proceeds to Step S1213.

In Step S1213, the CPU 101 moves the value of the variable tbl_idx forward (Step S1213) and proceeds to Step S1217. The process in Step S1213 is the same as the process in Step S1204 described above, and therefore its explanation will be omitted.

If the CPU 101 determines in Step S1210 that high_flg is false (Step S1210; NO), the CPU 101 determines whether the one-previous element of note_buf is less than the current element of note_buf (Step S1214). If the CPU 101 determines that the one-previous element is less than the current element (Step S1214; YES), the CPU 101 subtracts 12 from the current element (Step S1215) and proceeds to Step S1216. In other words, the CPU 101 descends the pitch by one octave. If the CPU 101 determines that the one-previous element is not less than the current element (Step S1214; NO), the CPU 101 proceeds to Step S1216.

In Step S1216, the CPU 101 moves the value of the variable tbl_idx backward (Step S1216) and proceeds to Step S1217. The process in Step S1216 is the same as the process in Step S1206 described above, and therefore its explanation will be omitted.

In Step S1217, the CPU 101 increases the variable i by one (Step S1217) and determines whether i is less than 5 (Step S1218). If the CPU 101 determines that i is less than 5 (Step S1218; YES), the CPU 101 returns to Step S1208 and repeats the processes in Step S1208 and thereafter. This sets the elements of index 1 to index 4 of note_buf, which is the sound emission candidate buffer. These serve as the second to fifth candidates. In this process, when the key pressed by the player is in the ascending direction, the selected second candidate is always a pitch higher than the first candidate, and thereafter candidates are set in note_buf in ascending order. Conversely, when the key pressed by the player is in the descending direction, the selected second candidate is always a pitch lower than the first candidate, and thereafter candidates are set in note_buf in descending order. If the CPU 101 determines that i is 5 or more (Step S1218; NO), the CPU 101 sets the value of the variable now_key in the variable prev_key (Step S1219) and proceeds to Step S1003 in FIG. 10.

In Step S1003 in FIG. 10, the CPU 101 executes a not-being-emitted pitch search process. The not-being-emitted pitch search process is a process of checking/determining whether musical tones of pitches (candidates) in the sound emission candidate buffer are currently being emitted, starting from the first candidate, and determining a candidate not being emitted as a pitch to be emitted (sound emission pitch).

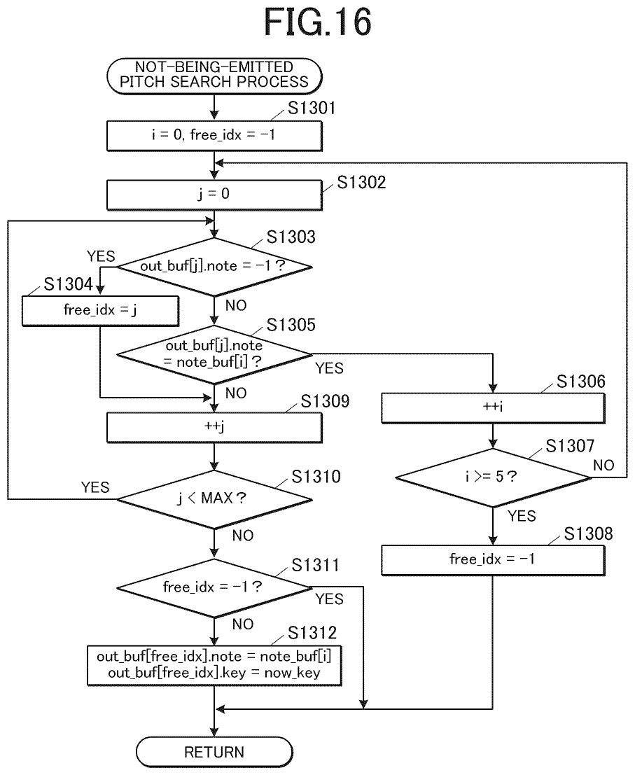

As shown in FIG. 16, in the not-being-emitted pitch search process, the CPU 101 first sets 0 in the variable i, which is used as an index of note_buf, which is the buffer of sound emission candidates (first to fifth candidates), and sets −1 , which indicates an invalid state, in the variable free_idx, which indicates a free index of out_buf, which is the buffer of the pitch of the musical tone being emitted (Step S1301). Further, the CPU 101 initializes a variable j, which is used as an index of out_buf, to 0 (Step S1302). The out_buf is an array of a structure, and has, as members of the structure, a key member, which is the pitch of the pressed key, and a note member, which is the pitch of the musical tone actually being emitted by the pressed key. The number of elements of the array is described by the constant MAX, but it is a numerical value to be determined in accordance with the number of sounds that the sound source 108 can emit at the same time and the specifications of the electronic musical instrument 1. Although 32 is assumed as the constant MAX in this embodiment, a different value may be selected.

Next, the CPU 101 determines whether the note member of the j^{th} element of out_buf is −1 (Step S1303). The note member of the j^{th} element being −1 indicates that the element is free (vacant). If the CPU 101 determines that the note member of the j^{th} element of out_buf is −1 (Step S1303; YES), the CPU 101 stores the value of the variable j in the variable free_idx (Step S1304) and proceeds to Step S1309. In the case where the note member of the j^{th} element of out_buf is −1 , a sound emission pitch can be assigned to the j^{th} element later, so that the value of the variable j is stored in the variable free_idx, which indicates the free index.

If the CPU 101 determines that the note member of the j^{th} element of out_buf is not-1 (Step S1303; NO), the element is being emitted. The CPU 101 then compares the note member of the element with the i^{th} element of note_buf (Step S1305). If they are equal (Step S1305; YES), the CPU 101 increases i by one (Step S1306). The note member of the j^{th} element of out_buf and the i^{th} element of note_buf being equal means that the i^{th} element (sound emission candidate) of note_buf is being emitted. The CPU 101 then increases i by one to compare the next element of note_buf with the note member of out_buf.

Next, the CPU 101 determines whether i is 5 or more (Step S1307). If the CPU 101 determines that i is not 5 or more (Step S1307; NO), the CPU 101 returns to Step S1302 and repeats the processes in Step S1302 and thereafter. If the CPU 101 determines that i is 5 or more (Step S1307; YES), the CPU 101 sets −1 , which indicates invalid, in the variable free_idx (Step S1308) and proceeds to Step S904. The i being 5 or more means that all the sound emission candidates are being emitted and accordingly sound emission is given up. The CPU 101 therefore sets −1 , which indicates invalid, in the variable free_idx.

If the note member of the j^{th} element of out_buf and the i^{th} element of note_buf are not equal (Step S1305; NO), the CPU 101 increases j by one (Step S1309) to compare the next element of out_buf with the value of the i^{th} element of note_buf.

Next, the CPU 101 determines whether j is less than MAX (the number of elements of the array) (Step S1310). If the CPU 101 determines that j is less than MAX (Step S1310; YES), the CPU 101 returns to Step S1303 and compares the next element with the value of note_buf. If the CPU 101 determines that the variable j has reached MAX (Step S1310; NO), the CPU 101 determines whether the variable free_idx is −1 (Step S1311). The j having reached MAX means that all the elements of out_buf, namely, the pitches of all the musical tones being emitted, do not match the i^{th} element of note_buf. In other words, the candidate(s) in note_buf[i] is not being emitted, and therefore it can be emitted if there is room in out_buf. However, if the variable free_idx is −1 , it means that there is no room in the sound emitting buffer, and therefore no sound can be emitted.

If the CPU 101 determines that the variable free_idx is −1 (Step S1311; YES), the CPU 101 proceeds to Step S904 in FIG. 9. If the CPU 101 determines that the variable free_idx is not −1 (Step S1311; NO), the CPU 101 sets the value of note_buf[i] in the note member of out_buf[free_idx] and sets the value of the variable now_key, which indicates the pressed-key's pitch, in the key member of out_buf[free_idx] (Step S1312) and proceeds to Step S904 in FIG. 9. The pitch set in the note member of out_buf[free_idx] is the pitch of the musical tone to be emitted (determined pitch).

In Step S904 in FIG. 9, the CPU 101 determines whether the variable free_idx is −1 (Step S904).

If the CPU 101 determines that the variable free_idx is not-1 (Step S904; NO), the CPU 101 generates and outputs, to the sound source 108, sound emission instruction information on the pitch determined by the keyboard algorithm (Step S905) and ends the performance operation process. If the CPU 101 determines that the variable free_idx is −1 (Step S904; YES), the CPU 101 ends the performance operation process.

If the CPU 101 determines in Step S902 that the performance information input from the keyboard 107 does not indicate that a key has been pressed but indicates that a key has been released (Step S902; NO), the CPU 101 executes a mute process (Step S906) and ends the performance operation process.

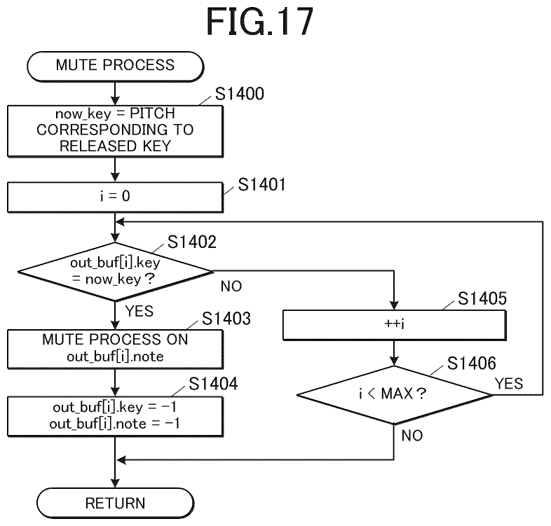

As shown in FIG. 17, in the mute process, the CPU 101 first sets the pitch of the released key in the variable now_key (Step S1400). Further, the CPU 101 sets 0 in the variable i (Step S1401), which indicates an index of out_buf.

Next, the CPU 101 determines whether the value of the key member of out_buf[i] is equal to the value of the variable now_key (Step S1402). If the CPU 101 determines that the value of the key member of out_buf[i] is equal to the value of the variable now_key (Step S1402; YES), the CPU 101 generates and outputs, to the sound source 108, mute instruction information on the pitch of the note member of out_buf[i] (Step S1403). The key member of out_buf[i] being equal to the pitch of the released key means that the note member of out_buf[i] is the sound to be muted.

Next, the CPU 101 sets −1 in the key member and the note member of out_buf[i] to indicate that the element of out_buf[i] is free (Step S1404) and ends the performance operation process.

If the CPU 101 determines that the value of the key member of out_buf[i] is not equal to the value of the variable now_key (Step S1402; NO), the CPU 101 increases i by one to move to the next element of out_buf (Step S1405). Next, the CPU 101 determines whether i is less than the number of elements MAX of out_buf (Step S1416). If the CPU 101 determines that i is less than the number of elements MAX of out_buf (Step S141; YES), the CPU 101 returns to Step S1402 and repeats the processes in Step S1402 and thereafter. If the CPU 101 determines that i has reached the number of elements MAX of out_buf (Step S1416; NO), the CPU 101 ends the performance operation process.

In Step S901 in FIG. 9, if the CPU 101 determines that no music piece is in progress (Step S901; NO), the CPU 101 determines whether the input performance information is information indicating that a key has been pressed (Step S907). If the CPU 101 determines that the input performance information is information indicating that a key has been pressed (Step S907; YES), the CPU 101 generates and outputs, to the sound source 108, sound emission instruction information at the pitch of the pressed key (Step S908) and ends the performance operation process. If the CPU 101 determines that the input performance information is not information indicating that a key has been pressed but information indicating that a key has been released (Step S907; NO), the CPU 101 generates and outputs, to the sound source 108, mute instruction information on the pitch of the released key (Step S909) and ends the performance operation process.

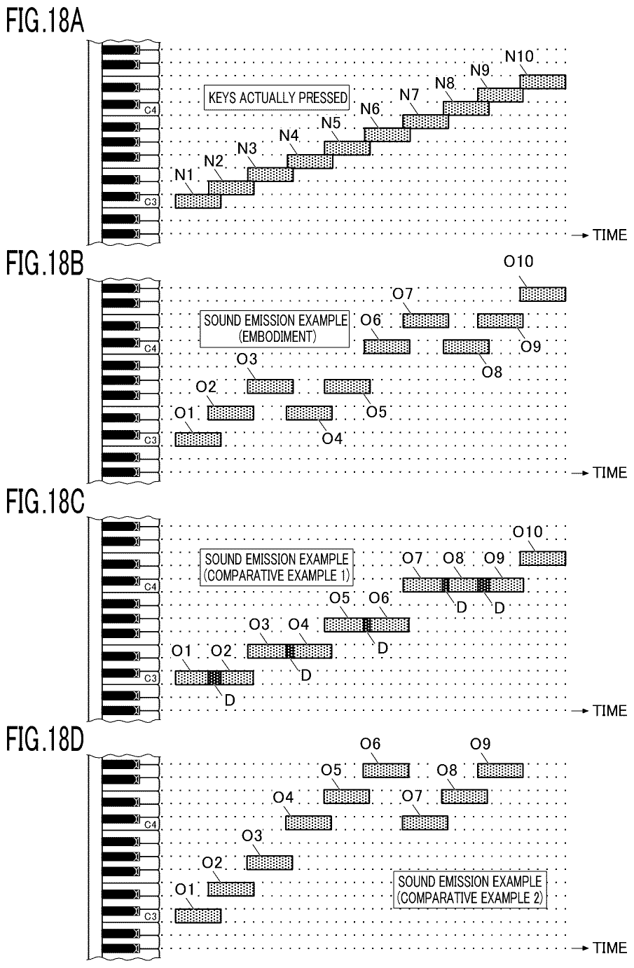

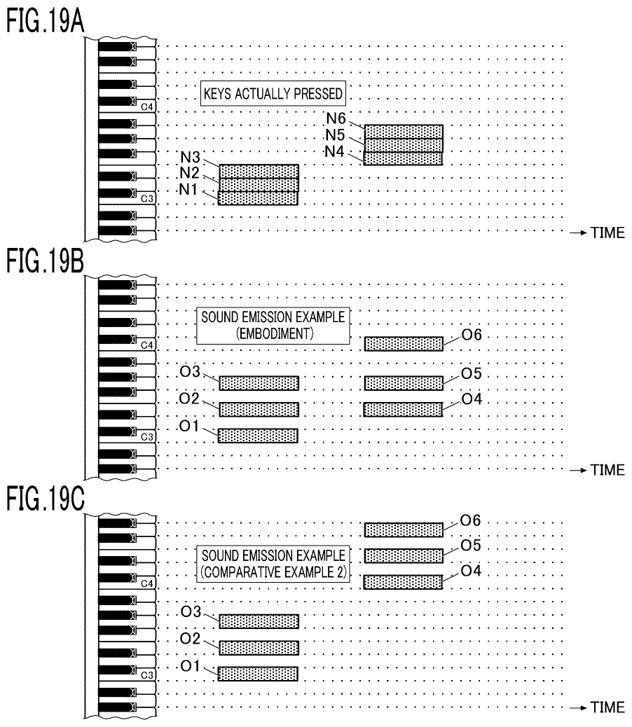

Hereinafter, advantageous effects of this embodiment will be described with reference to FIG. 18A to FIG. 19C. Each rectangle in FIG. 18A to FIG. 19C indicates a pitch using its position in the vertical position and a duration using its position in the horizontal direction. On the left side in each of FIG. 18A to FIG. 19C, a keyboard is shown to easily recognize the pitches. In examples described below, the chord is C major (chord constituent notes of C, E and G).

FIG. 18A shows an example of pressed keys in a case where the player performs legato playing from C3 to E4 of the keyboard 107. In FIG. 18A, reference signs of N1 to N10 are attached to the pressed keys. Even in a case of no legato playing, it is normal for the end of a pressed key and the beginning of the next pressed key to overlap somewhat, unless the player consciously plays with staccato touches. In other words, there is a time period during which two keys are pressed at the same time.

FIG. 18B shows a sound emission example of this embodiment when the player does the performance shown in FIG. 18A. In FIG. 18B, emitted sounds corresponding to the pressed keys N1 to N10 in FIG. 18A are indicated by O1 to O10. Since C3 is the chord constituent note closest to the pitch C3 of the first pressed key N1, C3 is emitted first as the sound O1 corresponding to the pressed key N1. The chord constituent note closest to the pitch D3 of the second pressed key N2 is C3, but C3 is being emitted. Further, the position of D3 currently pressed is on the higher pitch side of C3 previously pressed. Therefore, E3, which is the chord constituent note second closest to C3 (i.e., closest to the pitch D3 of the pressed key N2) among not-being-emitted chord constituent notes higher than C3, is emitted as the sound O2 corresponding to the pressed key N2.The chord constituent note closest to the pitch E3 of the third pressed key N3 is E3, but E3 is being emitted. Further, the position of E3 currently pressed is on the higher pitch side of D3 previously pressed. Therefore, G3, which is the chord constituent note second closest to E3 (i.e., closest to the pitch E3 of the pressed key N3) among not-being-emitted chord constituent notes higher than E3, is emitted as the sound O3 corresponding to the pressed key N3. The chord constituent note closest to the pitch F3 of the fourth pressed key N4 is E3. E3 is not being emitted at this point. Therefore, E3 is emitted as the sound O4 corresponding to the pressed key N4. Similarly, the sound emission pitch is determined thereafter too. There are sections where the sound emission pitch descends by three half steps (to the sound O4 and the sound O8), but the sound emission pitch at each of these points is the chord constituent note closest to the pitch of the key pressed by the player, and because of this descended pitch, pitches that deviate from the pitches of the pressed keys are not emitted with respect to the subsequent pressed keys too. Thus, in this embodiment, among the chord constituent notes, the musical tone of the pitch closest to the pitch of the pressed key is emitted, and if the musical tone of the closest pitch is being emitted, a not-being-emitted pitch is selected from among the chord constituent notes on the basis of the direction of the pitch of the currently pressed key with respect to the previously pressed key, and is emitted. Thus, as shown in FIG. 18B, the player's performance intention can be appropriately reflected and pitches that do not deviate from the pitches of the pressed keys can be emitted. According to the embodiment of the present disclosure, the pitch to be emitted does not necessarily match the pitch specified by the user. There are cases where if a sound is emitted at the pitch specified by the user, the sound is dissonant in relation to the accompaniment sound being played back. According to the embodiment of the present disclosure, the pitch to be emitted in response to the pitch specified by the user is the pitch determined from among the chord constituent notes, so that it does not become dissonant in relation to the accompaniment sound being played back.
FIG. 18C shows a sound emission example of Comparative Example 1 (JP 2000-172253 A) when the player does the performance shown in FIG. 18A. In FIG. 18C, emitted sounds corresponding to the pressed keys N1 to N10 in FIG. 18A are indicated by O1 to O10. In Comparative Example 1, the chord constituent note closest to the pitch of each pressed key is emitted. Since the determination is made solely on the basis of a chord constituent note(s) that is close to the pitch of each pressed key, the musical tone of the same pitch C3 is emitted as the sound O1 corresponding to the pressed key N1 with which C3 is pressed and as the sound O2 corresponding to the pressed key N2 with which D3 is pressed. Similarly, the musical tone of the same pitch E3 is emitted as the sound O3 corresponding to the pressed key N3 with which E3 is pressed and as the sound O4 corresponding to the pressed key N4 with which F3 is pressed. Multiple pressed keys emit the musical tone of the same pitch thereafter too. In other words, even when the player is doing the performance by changing keys to press, the same sound is emitted continuously, and accordingly the player's performance intention cannot be reflected. In Comparative Example 1, there are sections D in each of which two notes (sounds) of the same pitch are emitted at the same time. Since an electronic musical instrument using a general PCM sound source outputs musical tones using the same waveform data for the same pitch, phase interference may occur due to a gap in sound emission timing, causing sounds to cancel each other out or to generate undulation, which is undesirable.
FIG. 18D shows a sound emission example of Comparative Example 2 (JP 2004-177893 A) when the player does the performance shown in FIG. 18A. In FIG. 18D, emitted sounds corresponding to the pressed keys N1 to N10 in FIG. 18A are indicated by O1 to O10. In Comparison Example 2, if the key pressed by the player is higher than the key pressed before that, as a chord constituent note to be emitted, a not-being-emitted pitch higher than the chord constituent note emitted immediately before is selected. If there is no not-being-emitted pitch higher than the chord constituent note emitted immediately before in the candidate buffer, the chord constituent note next to the chord constituent note emitted immediately before is adjusted to be one octave higher and emitted. If the key pressed by the player is lower than the key pressed before that, the process(es) with the “higher” above replaced with “lower” is executed. The octave of the selected pitch is corrected in accordance with the octave difference between a reference octave and the octave of the pressed key.

In Comparative Example 2, since the pitches of the pressed keys N1 to N3 are in the ascending direction, C3, E3 and G3 are selected and emitted in order as the sounds O1 to O3 as shown in FIG. 18D. For the pressed key N4 with which F3 is pressed, C3 is selected, but since it is a pressed key in the ascending direction, C4, which is one octave higher than C3, is emitted as the sound O4. Similarly, E4 and G4 are emitted as the sounds O5 and O6 corresponding to the pressed keys N5 and N6, respectively. In Comparative Example 2, only adjustment up to one octave higher is mentioned, so that C4, E4 and G4 are repeatedly emitted as the sounds O7 to O9 corresponding to the pressed keys N7 to N9. Although not shown, the octave region of the pressed key N10 is different from the octave region of the pressed keys so far, and therefore if the original octave region of pressed keys is used as a reference octave region, C5, which is one octave higher than C4, is emitted as the sound O10 corresponding to the pressed key N10. In Comparative Example 2, the pitch ascends until a halfway point, and the player's performance intention is reflected, but the pitch drops seven half steps at a point, and the pitch is far different from the actually performed pitch thereafter.

FIG. 19A shows an example of pressed keys in a case where the player plays chords. Reference signs of N1 to N6 are attached to the pressed keys. As shown in FIG. 19A, first, C3, D3 and E3 are pressed almost simultaneously (pressed keys a) as the pressed keys N1 to N3, and then F3, G3 and A3 are pressed almost simultaneously (pressed keys b) as the pressed keys N4 to N6. Among the pressed keys a and among the pressed keys b, a key on the lower pitch side is pressed earlier in time. In other words, the direction of the pressed keys a and the direction of the pressed keys b are both the ascending direction.

FIG. 19B shows a sound emission example of this embodiment when the player plays the chords shown in FIG. 19A. In FIG. 19B, emitted sounds corresponding to the pressed keys N1 to N6 in FIG. 19A are indicated by O1 to O6. As the sounds O1 to O3 corresponding to the pressed keys N1 to N3 of the pressed keys a, C3, E3 and G3 are emitted. For the pressed key N4 (pitch F3) of the pressed keys b, E3, which is the closest chord constituent note, is emitted. For the pressed key N5 (pitch G3), G3, which is the closest chord constituent note, is emitted. For the pressed key N6 (pitch A3), the closest chord constituent note is G3, but because it is being emitted, C4, which is the chord constituent note second closest to G3 (i.e., closest to the pitch A3 of the pressed key N6) among not-being-emitted chord constituent notes higher than G3, is emitted as the sound O6corresponding to the pressed key N6. As shown in FIG. 19B, in this embodiment, the musical tone of the pitch closest to the pitch of the pressed key among the chord constituent notes is emitted, and if the musical tone of the closest pitch is being emitted, a not-being-emitted pitch among the chord constituent notes is selected and emitted on the basis of the direction of the pitch of the currently pressed key with respect to the previously pressed key. Thus, in the case of playing/inputting chords too, pitches in which the player's performance intention is reflected can be emitted. Further, since a not-being-emitted pitch is selected, the pitch to be emitted is not the same as the pitch(es) being emitted. In other words, the chordal performance can also be handled.

FIG. 19C shows a sound emission example of Comparative Example 2 when the player plays the chords shown in FIG. 19A. In FIG. 19C, emitted sounds corresponding to the pressed keys N1 to N6 in FIG. 19A are indicated by O1 to O6. As the sounds O1 to O3 corresponding to the pressed keys N1 to N3 of the pressed keys a, C3, E3 and G3 are emitted. For the pressed key N4 (pitch F3) of the pressed keys b, within the same octave region, there is no chord constituent note of C chord higher than G3 emitted in response to E3 of the pressed key N3, so that C3 is targeted again, and in order to make the pitch higher than G3 emitted as the sound O3 corresponding to the pressed key N3, C4, which is one octave higher than C3, is emitted. Similarly, E4 and G4 are emitted as the sounds O5 and O6 corresponding to the pressed keys N5 and N6, respectively. In other words, high pitches that deviate from the pitches of the keys pressed by the player are emitted (sounded).

In the keyboard algorithm described with reference to FIG. 10, after the first to fifth candidates are determined and stored in note_buf, note_buf is checked to see if the candidates are being emitted, starting from the first candidate, and if a candidate is not being emitted, it is emitted. In other words, after all the candidates are determined, whether the candidates are being emitted is checked. Alternatively, each time a candidate is determined, whether the determined candidate is being emitted may be checked, and if it is not being emitted, it may be determined as the determined pitch, and no further candidate may not be calculated. Thus, if a calculated candidate is not being emitted, it can be emitted immediately as the determined pitch, and the process of calculating a candidate(s) becomes unnecessary to be executed thereafter, which can reduce the processing load.

As described above, the CPU 101 of the electronic musical instrument 1 determines a first pitch that (i) corresponds to one of chord constituent notes that correspond to chord information at a timing at which a key of the keys is pressed by the user, the chord information being obtained from a music piece, and (ii) is closest to a pitch corresponding to the pressed key. In response to the musical tone of the first pitch being not emitted, the CPU 101 causes the sound emitter 111 to emit the musical tone of the first pitch. In response to the musical tone of the first pitch being emitted, the CPU 101 causes the sound emitter 111 to emit the musical tone of a second pitch that corresponds to another one of the chord constituent notes and is present in the direction viewed from the first pitch, the direction being identical with the direction in which the pitch corresponding to the key currently pressed is viewed from a pitch corresponding to a key of the keys previously pressed. This makes it possible, in response to a performance operation made by the user, to emit a good musical tone that reflects the user's performance intention and is in harmony with a chord of a music piece.

For example, in response to the musical tone of the first pitch being emitted and the direction in which the pitch corresponding to the key currently pressed is viewed from the pitch corresponding to the key previously pressed being the ascending direction, the CPU 101 causes the sound emitter 111 to emit, as the second pitch, a pitch that is included in the chord constituent notes and higher than the first pitch. This makes it possible, when the user presses a key in the ascending direction of pitches, to emit a good musical tone that reflects the user's intention to play in the ascending direction.

For example, the CPU 101 causes the sound emitter 111 to emit, as the second pitch, among the pitch(es) that is included in the chord constituent notes, higher than the first pitch and not being emitted, the pitch closest to the pitch corresponding to the key currently pressed. This makes it possible to emit a good musical tone that is in harmony with a chord of a music piece without deviating from the user's performance, canceling sounds each other out, or causing sounds to generate undulation.

Further, for example, in response to the musical tone of the first pitch being emitted and the direction in which the pitch corresponding to the key currently pressed is viewed from the pitch corresponding to the key previously pressed being the descending direction, the CPU 101 causes the sound emitter 111 to emit, as the second pitch, a pitch that is included in the chord constituent notes and lower than the first pitch. This makes it possible, when the user presses a key in the descending direction of pitches, to emit a good musical tone that reflects the user's intention to play in the descending direction.

For example, the CPU 101 causes the sound emitter 111 to emit, as the second pitch, among the pitch(es) that is included in the chord constituent notes, lower than the first pitch and not being emitted, the pitch closest to the pitch corresponding to the key currently pressed. This makes it possible to emit a good musical tone that is in harmony with a chord of a music piece without deviating from the user's performance, canceling sounds each other out, or causing sounds to generate undulation.

Those described in the above embodiment are not limitations but some preferable examples of the electronic musical instrument, the control method and the storage medium storing the program(s) according to the present disclosure.

For example, although in the above embodiment, the functions of the present disclosure are realized by the CPU 101 of the electronic musical instrument 1 executing the main process described above in cooperation with the programs stored in the ROM 102 of the electronic musical instrument 1, the functions of the present disclosure may be realized by a computer that is a separate unit from the electronic musical instrument 1 and connected with the electronic musical instrument 1.

Further, although in the above embodiment, the electronic musical instrument 1 is a keyboard instrument, the electronic musical instrument of the present disclosure may be another electronic musical instrument, such as a wind synthesizer, an electric guitar or an MIDI violin.

Further, although in the above embodiment, the computer-readable storage medium storing the programs of the present disclosure is a semiconductor memory, such as a ROM, or a hard disk, the computer-readable storage medium is not limited thereto. As the computer-readable storage medium, a portable storage medium, such as a CD-ROM, can be used appropriately. Further, a carrier wave can also be used appropriately as a storage medium that provides data of the programs of the present disclosure via a communication line.

Further, the detailed configuration and detailed operation of the electronic musical instrument 1 can be changed as appropriate without departing from the scope of the present disclosure.

Although one or more embodiments of the present disclosure have been described above, the technical scope of the present disclosure is not limited to the embodiments described above but defined on the basis of claims. The technical scope of the present disclosure includes not only the scope of claims but also the scope of claims with changes unrelated to the essence of the present disclosure added.

1. An electronic musical instrument comprising:
a plurality of operation elements;
a sound emitter; and
a processor that:
starts a music piece advancing process based on music piece data,
determines a first pitch that (i) corresponds to one of chord constituent notes that correspond to chord information at a timing at which an operation element of the plurality of operation elements is specified by a user, the chord information being obtained from the music piece data, and (ii) is closest to a pitch corresponding to the specified operation element,
in response to a musical tone of the first pitch being not emitted, causes the sound emitter to emit the musical tone of the first pitch, and
in response to the musical tone of the first pitch being emitted, causes the sound emitter to emit a musical tone of a second pitch that corresponds to another one of the chord constituent notes and is present in a direction viewed from the first pitch, the direction being identical with a direction in which the pitch corresponding to the operation element currently specified is viewed from a pitch corresponding to an operation element of the plurality of operation elements previously specified.

2. The electronic musical instrument according to claim 1, wherein in response to the musical tone of the first pitch being emitted and the direction in which the pitch corresponding to the operation element currently specified is viewed from the pitch corresponding to the operation element previously specified being an ascending direction, the processor causes the sound emitter to emit, as the second pitch, a pitch that is included in the chord constituent notes and higher than the first pitch.

3. The electronic musical instrument according to claim 2, wherein the processor causes the sound emitter to emit, as the second pitch, among the pitch that is included in the chord constituent notes, higher than the first pitch and not being emitted, a pitch closest to the pitch corresponding to the operation element currently specified.

4. The electronic musical instrument according to claim 1, wherein in response to the musical tone of the first pitch being emitted and the direction in which the pitch corresponding to the operation element currently specified is viewed from the pitch corresponding to the operation element previously specified being a descending direction, the processor causes the sound emitter to emit, as the second pitch, a pitch that is included in the chord constituent notes and lower than the first pitch.

5. The electronic musical instrument according to claim 4, wherein the processor causes the sound emitter to emit, as the second pitch, among the pitch that is included in the chord constituent notes, lower than the first pitch and not being emitted, a pitch closest to the pitch corresponding to the operation element currently specified.

6. The electronic musical instrument according to claim 1, wherein the processor:
converts the pitch corresponding to the operation element specified by the user into a pitch name, and
determines the first pitch based on the pitch name and pitch names indicated by the chord constituent notes.

7. The electronic musical instrument according to claim 1, wherein the processor:
converts the pitch corresponding to the operation element specified by the user into a pitch name number, and
determines the first pitch based on a difference between the pitch name number and each of pitch name numbers indicated by the chord constituent notes.

8. The electronic musical instrument according to claim 1, wherein the processor:
obtains an octave region and a pitch name of the pitch corresponding to the operation element specified by the user, and
determines the first pitch based on the octave region and the pitch name.

9. A control method that is executed by a computer, the control method comprising:
starting a music piece advancing process based on music piece data;
determining a first pitch that (i) corresponds to one of chord constituent notes that correspond to chord information at a timing at which an operation element of a plurality of operation elements is specified by a user, the chord information being obtained from the music piece data, and (ii) is closest to a pitch corresponding to the specified operation element;
in response to a musical tone of the first pitch being not emitted, causing a sound emitter to emit the musical tone of the first pitch; and
in response to the musical tone of the first pitch being emitted, causing the sound emitter to emit a musical tone of a second pitch that corresponds to another one of the chord constituent notes and is present in a direction viewed from the first pitch, the direction being identical with a direction in which the pitch corresponding to the operation element currently specified is viewed from a pitch corresponding to an operation element of the plurality of operation elements previously specified.

10. The control method according to claim 9, wherein in response to the musical tone of the first pitch being emitted and the direction in which the pitch corresponding to the operation element currently specified is viewed from the pitch corresponding to the operation element previously specified being an ascending direction, the computer causes the sound emitter to emit, as the second pitch, a pitch that is included in the chord constituent notes and higher than the first pitch.

11. The control method according to claim 10, wherein the computer causes the sound emitter to emit, as the second pitch, among the pitch that is included in the chord constituent notes, higher than the first pitch and not being emitted, a pitch closest to the pitch corresponding to the operation element currently specified.

12. The control method according to claim 9, wherein in response to the musical tone of the first pitch being emitted and the direction in which the pitch corresponding to the operation element currently specified is viewed from the pitch corresponding to the operation element previously specified being a descending direction, the computer causes the sound emitter to emit, as the second pitch, a pitch that is included in the chord constituent notes and lower than the first pitch.

13. The control according to claim 12, wherein the computer causes the sound emitter to emit, as the second pitch, among the pitch that is included in the chord constituent notes, lower than the first pitch and not being emitted, a pitch closest to the pitch corresponding to the operation element currently specified.

14. The control method according to claim 9, wherein the computer:
converts the pitch corresponding to the operation element specified by the user into a pitch name, and
determines the first pitch based on the pitch name and pitch names indicated by the chord constituent notes.

15. The control method according to claim 9, wherein the computer:
converts the pitch corresponding to the operation element specified by the user into a pitch name number, and
determines the first pitch based on a difference between the pitch name number and each of pitch name numbers indicated by the chord constituent notes.

16. The control method according to claim 9, wherein the computer:
obtains an octave region and a pitch name of the pitch corresponding to the operation element specified by the user, and
determines the first pitch based on the octave region and the pitch name.

17. A non-transitory computer-readable storage medium storing a program causing a computer to:
start a music piece advancing process based on music piece data;
determine a first pitch that (i) corresponds to one of chord constituent notes that correspond to chord information at a timing at which an operation element of a plurality of operation elements is specified by a user, the chord information being obtained from the music piece data, and (ii) is closest to a pitch corresponding to the specified operation element;
in response to a musical tone of the first pitch being not emitted, cause a sound emitter to emit the musical tone of the first pitch; and
in response to the musical tone of the first pitch being emitted, cause the sound emitter to emit a musical tone of a second pitch that corresponds to another one of the chord constituent notes and is present in a direction viewed from the first pitch, the direction being identical with a direction in which the pitch corresponding to the operation element currently specified is viewed from a pitch corresponding to an operation element of the plurality of operation elements previously specified.
